(19) United States
(12) Patent Application Publication
(10) Pub. No.: US 2008/0206116 A1
(43) Pub. Date: Aug. 28, 2008

(54) FRICTION STIR WELDING METHOD FOR LAMINATED MEMBER AND HYDROGEN REACTOR

(76) Inventors: Akihiro SATOU, Naka (JP); Takao Ishikawa, Hitachi (JP); Kinya Aota, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/023,422

(22) Filed: Jan. 31, 2008

(30) Foreign Application Priority Data
Feb. 28, 2007 (JP) 2007-048366

(51) Int. Cl. B01J 19/00; B23K 20/12; B32B 15/01

(52) U.S. Cl. 422/187; 228/112.1; 428/615

(57) ABSTRACT

The present invention is relates to a method for alternately laminating each first metal sheet and each second metal sheet in three or more layers, wherein a melting point of the second metal sheet is higher than that of the first metal sheet, and welding them together by friction stir welding.

Furthermore, under a state where those three or more metal sheets are so laminated that an edge of the first metal sheet protrude outward compared to an edge of the second metal sheet, the friction stir welding is executed by pressing a welding tool against only the edge of the first metal sheet.

### CLAIM OF PRIORITY

The present application claims priority from Japanese application serial no. 2007-48366, filed on Feb. 28, 2007, the contents of which are hereby incorporated by references into this application.

### FIELD OF THE INVENTION

The present invention relates to friction stir welding methods of inserting a rotary tool as welding tool into a joining section of metal sheets to be joined (welded) and joining them together utilizing frictional heat produced by rotation of the rotary tool, and in particular to a method for joining laminated dissimilar metal sheets.

### BACKGROUND OF THE INVENTION

The friction stir welding method includes the following steps of: inserting a rotary tool (welding tool), which is harder than metal sheets to be joined, into a join section of the metal sheets, and welding the metal sheets to each other by frictional heat produced between the rotary tool and the join section of the metal sheets, wherein the friction heat is produced by rotating the rotary tool. That is, it utilizes a plastic flow caused by frictional heat between the rotary tool and the metal sheets to be joined and is not designed to melt metal materials to join them unlike arc welding. This joining method is different from conventional methods, such as rotational friction welding of rotating both materials to be joined and joining them together by frictional heat between them. With the friction stir welding method using a rotary tool, materials to be joined can be continuously joined together in the direction of join line, that is, in the direction of length.

Japanese Patent Laid-Open No. 2001-314981 discloses a technique of joining two members of a lap joint to each other by utilizing the friction stir welding. This prior art discloses that: a welding tool has a flat tip surface or a recess in its tip surface; the welding tool makes frictional stir to one member by press fitting into the member, and at the same time, also makes frictional stir to the other member, thereby joining both the members together.

For example, reformers for town gas and reactors for causing dehydrogenation reaction from organic hydride use a hydrogen separation membrane to lower a reaction temperature and supply high-purity hydrogen. The hydrogen separation membrane is metal foil based on palladium (hereafter, described as Pd), niobium, zirconium, or the like. For catalyst, a high thermal conductive base material, such as aluminum (hereafter, described as Al), is used because the hydrogen generation reaction is endothermic.

When metal members different in melting point are joined into a lap joint to fabricate a reactor, it used to be difficult to frictionally stir these members to be joined since these metal members are different in flow resistance. As an example, it will be assumed that an Al sheet, a Pd sheet, and an Al sheet are laminated in this order and joined together at a time. In this case, the melting point of Al is 660° C., and the melting point of Pd is far higher than that of Al. For this reason, a problem arises. When the upper sheet is of Al, since the middle sheet of Pd has a high melting point and a high flow resistance compared with the Al sheet, therefore, plastic flow of the Pd middle sheet does not occur. Consequently, it is impossible to join an Al lower sheet disposed under the Pd sheet together with the other two sheets by friction stir welding.

Reactors are used to supply a liquid or gaseous substance to cause dehydrogenation reaction. At this time, the interior of a reactor is exposed to hydrogen, and there is a possibility that degradation in the performance of material, such as hydrogen embrittlement, as results. An intermetallic compound produced in a joining section between dissimilar metal members causes degradation in fatigue strength or the like. With respect to hydrogen embrittlement as well, it is expected that the intermetallic compound will be more susceptible than the base metal.

### SUMMARY OF THE INVENTION

An object of the invention is to provide a friction stir welding method wherein three or more members of metal different in melting point can be simultaneously laminated and jointed together.

The present invention is relates to a method for alternately laminating each first metal sheet and each second metal sheet in three or more layers, wherein a melting point of the second metal sheet is higher than that of the first metal sheet, and welding them together by friction stir welding.

Furthermore, under a state where those three or more metal sheets are so laminated that an edge of said first metal sheet protrude outward of an edge of the second metal sheet, the friction stir welding is executed by pressing a welding tool against only the edge of the first metal sheet.

Further, a protruding section of the first metal sheet softens and plastically flows around a recessed edge of said second metal sheet by the friction stir welding and a resulting plastic flow section of the first metal sheet covers the edge of said second metal sheet.

In this friction stir welding method, a welding tool is pressed against only either member of them to cause friction stir. The plastic flow is caused at the joined interface between one member and the other member by this pressing force and frictional heat. Thus, a reaction layer can be formed in the joined interface between both the members, and this makes it possible to join dissimilar metal sheets together.

According to the invention, it is possible to provide a friction stir welding method with which three or more sheets of metal different in melting point can be alternately laminated and joined together.

### BRIEF DESCRIPTION OF THE DRAWINGS

FIG. 1 is a photo of a cross section of a join section obtained by joining an Al sheet and a Pd sheet together by friction stir according the invention;

FIG. 2 is a photo of a cross section of a lap joint obtained by joining an Al sheet and a Pd sheet using a laser beam;

FIG. 3 is a schematic diagram illustrating the disposition of members according to a first embodiment of the invention;

FIG. 4 is a schematic diagram illustrating where friction stir welding is carried out according to the invention;

FIG. 5 is a schematic diagram illustrating where friction stir welding is carried out according to a second embodiment of the invention;

FIG. 6 is a drawing illustrating a third embodiment of the invention;

FIG. 7 is a drawing illustrating a cross section of the joining section in the embodiment illustrated in FIG. 6; and

FIG. 8 is a drawing illustrating a fourth embodiment in which members are laminated and joined together according to the invention.

### DETAILED DESCRIPTION OF THE PREFERRED EMBODIMENTS

Description will be given to a method for laminating members and joining them together.

To implement the joining of the invention, it is required to use an apparatus at least comprised of a rotator shaft for rotating a welding tool as a joining tool; a thrust shaft for pressing the welding tool against members to be joined; and a movement shaft for moving the welding tool in the direction of a join line. The apparatus may be so structured that members to be joined are moved as long as the joining tool is rotated. The joining method of the invention can be implemented with such a machine tool as a milling machine or numeric controlled milling machine as long as the above requirements are met.

To fix members (work) to be joined, retaining jigs respectively corresponding to the shapes of the members are used. Especially, when thin sheet laminated structures are joined into a lap joint, the members to be joined are prone to be deformed when pressed by the welding tool. Therefore, it is desirable to continuously retain them around the join line in the direction of the join line.

The number of welding tool-rotations and the welding speed where the friction stir welding can be carried out, differ depending on the materials or sheet thicknesses of members to be joined. Though it cannot be categorically described, therefore, for example, a laminate comprises a Pd sheet with 0.1 mm thickness and two pure Al sheets with 0.2 mm thickness, and they can be simultaneously so laminated that the Pd sheet is sandwiched between the Al sheets and joined together by taking the following procedure. That is, a welding tool is pressed against only the Al sheets at the number of rotations of 18000 rpm and a joining speed of 1000 mm/min.

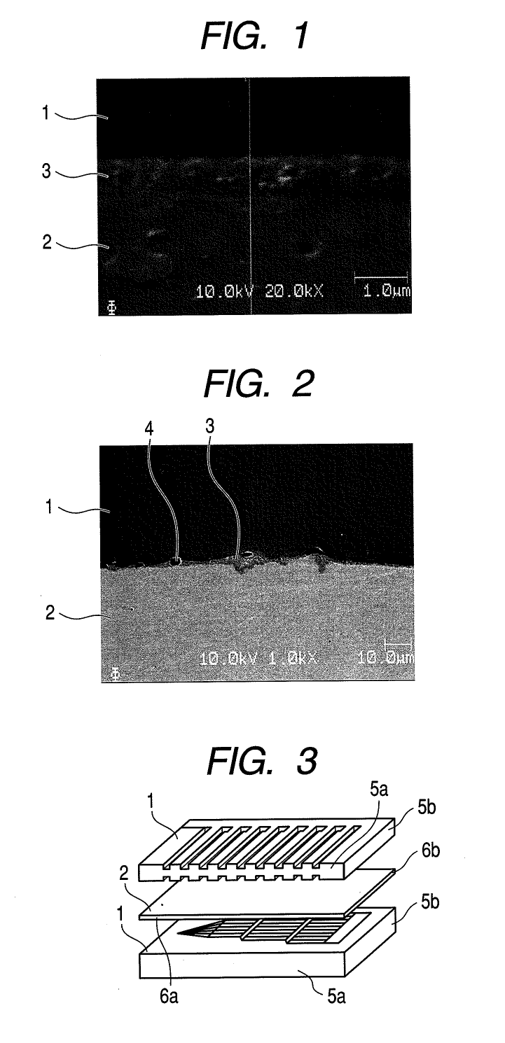

The photo of FIG. 1 illustrates the cross section of a joining section between an Al sheet 1 and a Pd sheet 2 joined by the friction stir welding method of the invention. According to the invention, a reaction layer 3 having a substantially constant thickness can be formed between the Al sheet 1 and the Pd sheet 2 after friction stir welding to the sheets. FIG. 2 illustrates a case where an Al sheet 1 and a Pd sheet 2 are joined together into a lap joint by laser welding. In this case, several voids 4 appearing to be blow holes are formed between the Al sheet 1 and the Pd sheet 2. The reaction layer 3 is divided by the voids 4 and as a result, it is discontinuous and is not constant in thickness. Further, the reaction layer 3 takes in more oxygen and the like than in joining by the invention. Therefore, joining by the invention is more favorable in quality than such melt welding as laser, and the effect of resistance to hydrogen embrittlement can be expected. Since the effect of resistance to hydrogen embrittlement can be expected from the joining method of the invention, the invention is especially effective for reactors in which hydrogen separation membrane are joined to the other members.

### First Embodiment

FIG. 3 illustrates a method for disposing members of a laminate according to the invention. The laminate in this embodiment is a hydrogen reactor having a laminated structure of Al sheet 1/Pd sheet 2/Al sheet 1. This structure is configured that a Pd sheet 2 as a hydrogen separation membrane is disposed over an Al sheet 1 as a catalyst sheet, and further an Al sheet 1 as a hydrogen channel sheet is disposed over the Pd sheet 2. The catalyst sheet 1 has such a construction that alumina to be a catalyst carrier is formed over an Al base sheet as a highly thermally-conductive sheet and Pt to be catalyst metal is supported over the catalyst carrier. In the catalyst sheet, there is formed a channel for supplying organic hydride to the catalyst and discharging it. In the hydrogen channel sheet, there is formed a channel for discharging hydrogen gas separated through the hydrogen separation membrane.

Description will be given to the functions of the hydrogen reactor. Organic hydride supplied to the hydrogen reactor passes through a catalyst face of the catalyst sheet and it thereby causes dehydrogenation reaction. Then, it is separated into hydrogen gas and waste liquid (dehydrogenated organic hydride). The waste liquid goes through a channel in the catalyst sheet and is discharged to outside the hydrogen reactor. The hydrogen gas generated from the organic hydride permeates the hydrogen separation membrane and moves to the hydrogen channel sheet side. As a result, the hydrogen gas is separated from the waste liquid and it goes through the hydrogen channel and is discharged to outside the hydrogen reactor and recovered there. Since the dehydrogenation reaction is an endothermic reaction, the hydrogen reactor is heated to 200 to 300° C. during being used.

Description will be given to a method for joining members in the laminate of Al sheet 1/Pd sheet 2/Al sheet 1 of the hydrogen reactor. The melting point of the Al sheets 1 is lower than the melting point of the Pd sheet 2. The sheets are so formed that sheet widths 5a, 5b of the Al sheets 1 are larger than sheet widths 6a, 6b of the Pd sheet 2. In this embodiment, the sheet widths 5a, 5b of the Al sheets 1 are respectively made larger than the sheet widths 6a, 6b of the Pd sheet 2 by 2.0 mm. As illustrated in FIG. 1, these sheets are so laminated that edges of the Al sheets 1 as a low-melting point metal are protruded outward compared to an edge of the Pd sheet 2 by 1.0 mm. That is, the both Al sheets 1 overhang the Pd sheet 2 in a sandwich structure. Therefore, the laminate's side face where the laminated members will be joined by the friction stir welding forms tongued and recessed face, and the tongued face (protruding section) are formed by the Al sheets 1.

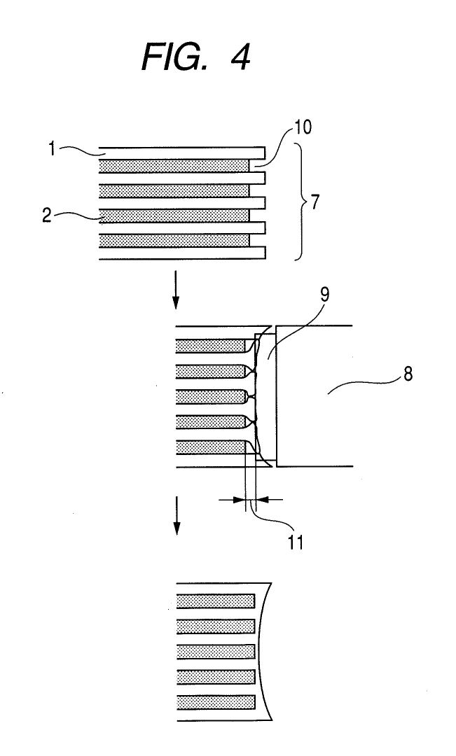

FIG. 4 illustrates where friction stir welding is carried out by the invention. The drawing illustrates the positional relation between a welding tool 8 and a joining section 7 established when the joining section 7 is subjected to friction stir welding by the welding tool 8. The welding tool 8 is commonly used in friction stir welding and has a probe 9 formed at its tip. The tip of the probe 9 is rotated at a number of rotations of 18000 rpm and is pressed only against the edges of the Al sheets 1 protruded outward of the Pd sheets 2. In this embodiment, the gap 11 between the tip of the probe 9 and the joint surfaces 10 of the Pd sheets 2 is set to 0.1 mm at this time. With the gap 11 kept constant, the welding tool 8 is moved at 1000 mm/min in the direction of joining. The Al sheets 1 and the Pd sheets 2 are thereby joined together throughout the circumference of the laminated member so that liquid leakage does not occur. In this joining method, the protruded Al sheets 1 are deformed (softened) by friction stir welding and plastically flow into the recesses in the gap 11, and the edges of the Pd sheets 2 are thereby covered. At this time, in the interface between Al that has plastically flowed and the edge of each Pd sheets 2, a reaction layer of Al and Pd is formed and the laminated sheets are thereby joined together. After joining, the upper and low faces and edge of the Pd sheets 2 are covered with the Al sheets 1. The photo of FIG. 1 illustrates the cross section of a joining section between the edges of the Al sheet 1 and the Pd sheet 2 joined together by this friction stir welding method. It is apparent from the photo that the reaction layer 3 having a substantially constant thickness of approximately 0.8 μm is formed between the Al sheet 1 and the Pd sheet 2 and the sheets are thereby joined together. It is desirable that the thickness of the reaction layer 3 should be not more than 5 μm in terms of bonding strength.

Any organic hydride can be used in the hydrogen reactor described in relation to this embodiment as long as it is an organic compound that repeatedly chemically stores and releases hydrogen. Of such organic compounds, aromatic compounds are preferable. Any or a mixture of benzene, toluene, xylene, mesitylene, naphthalene, methylnaphthalene, anthracene, biphenyl, phenathlene, and their alkyl substitution products can be utilized. For the highly thermally-conductive substrate and hydrogen channel sheet, a metal based on copper, nickel, aluminum, silicon, titanium, or the like or its alloy or cladding material can be used. For the catalyst carrier, at least one kind selected from a group composed of alumina, zincoxide, silica, zirconium oxide, diatomite, niobium oxide, vanadium oxide, activated carbon, zeolite, antimony oxide, titanium oxide, tungstic oxide, and ferric oxide. For the hydrogen separation membrane, such a metal as Pd, Nb, Zr, V, or Ta or its alloy can be used. For Nb or V metal, such an alloy of Mo, Co, Ni, or the like can be used.

In the description of this embodiment, joining of materials of Al sheet 1/Pd sheet 2/Al sheet 1 into a laminated member is taken as an example. The joining method of the invention is also applicable to any other dissimilar metals. In this case, it is important to laminate dissimilar metals with a low-melting point metal protruded so that a welding tool can be pressed only against the low-melting point metal for friction stir.

### Second Embodiment

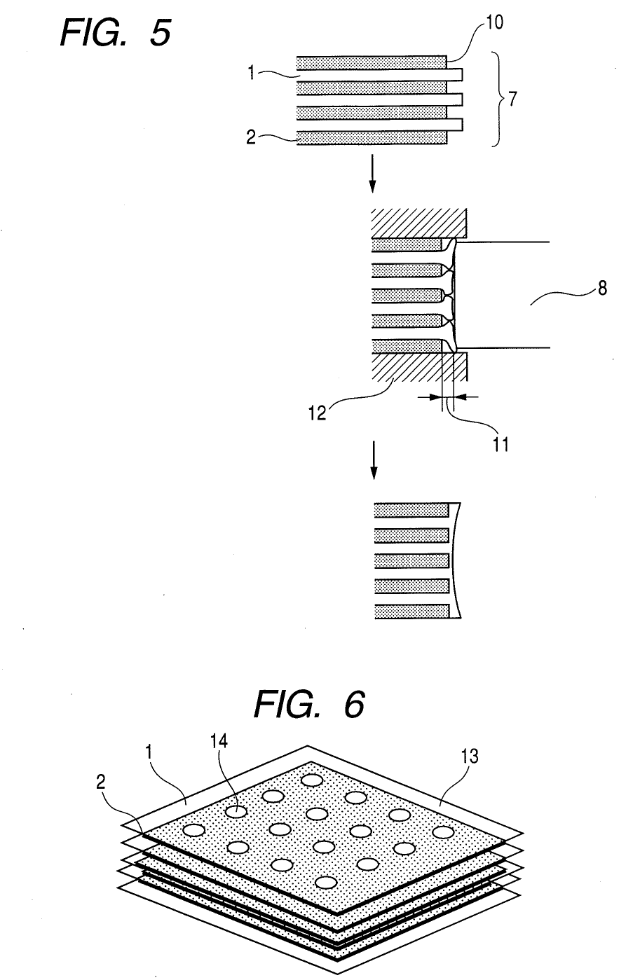

FIG. 5 illustrates an embodiment in which the disposition of the Al sheets 1 and Pd sheets 2 in the first embodiment is reversed and the Pd sheet 2 is disposed in the lowermost layer and the uppermost layer. Also in this embodiment, the sheets are laminated so that the Al sheets 1 having a low melting point are protruded as in the first embodiment. That is, each Al sheet 1 overhangs each Pd sheet 2. Then, the laminated Al sheets 1 and Pd sheets 2 are retained from above and below by a retaining jig 12. The retaining jig 12 plays a role of a wall for preventing the Al metal pressed by a welding tool 8 from being discharged to outside the laminated member. The tip of the welding tool 8 is rotated at a number of rotations of 18000 rpm and pressed against the portions (overhanging section) of the Al sheets 1 protruded outward of the Pd sheets 2. Also in this embodiment, the gap 11 established at this time is set to 0.1 mm. With the gap 11 kept constant, the welding tool 8 is moved at 1000 mm/min in the direction of joining. The Al sheets 1 and the Pd sheets 2 can be thereby joined together.

### Third Embodiment

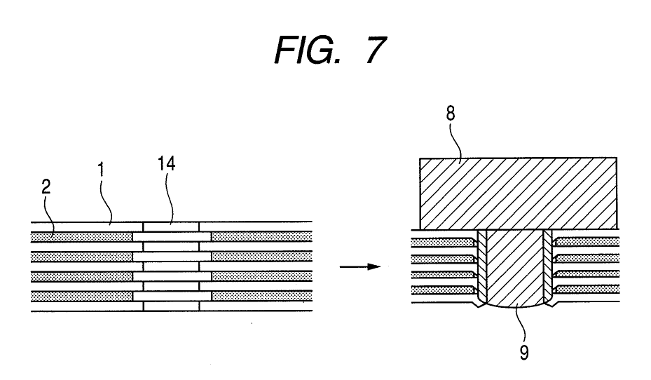

FIG. 6 illustrates a third embodiment in which members for the laminate are laminated and joined together using the invention. FIG. 7 illustrates the cross section of a joining area obtained at this time. This laminated member is of such a structure that each Al sheet 1 and each Pd sheet 2 are alternately laminated as with the first embodiment. Each of the laminated members is provided with a plurality of through holes 14, and the Al sheets 1 and the Pd sheets 2 are joined together in the through holes 14. The sheets (laminated members) 1 and 2 are so laminated that the Al sheets 1 are protruded outward of the Pd sheets 2 at the inner circumference of each through hole 14 that makes a joining section by 1.0 mm. FIG. 7 illustrates where sheets are joined together in a through hole 14. A welding tool 8 is rotated and inserted into the through hole 14 from the outer surface side 13, and thus only the Al sheets are frictionally stirred by the side face of its probe 9. This causes the Al sheets 1 to plastically flow and they are thereby joined with the joint surfaces 10 of the Pd sheets 2. This embodiment is implemented with the number of joining tool 8 rotations set to 18000 rpm.

When the method of joining in through holes in this embodiment is applied to the hydrogen reactor described in relation to the first embodiment, the following takes place: the joining sections in the through holes make heat collection paths and this facilitates supply of heat to the interior of the laminated member. As a result, it is possible to supply heat to the entire surfaces of the catalyst sheets and thus enhance the efficiency of dehydrogenation reaction. At this time, it is desirable to join the materials both at the outer circumferential surface of the laminated member and in the through holes.

### Fourth Embodiment

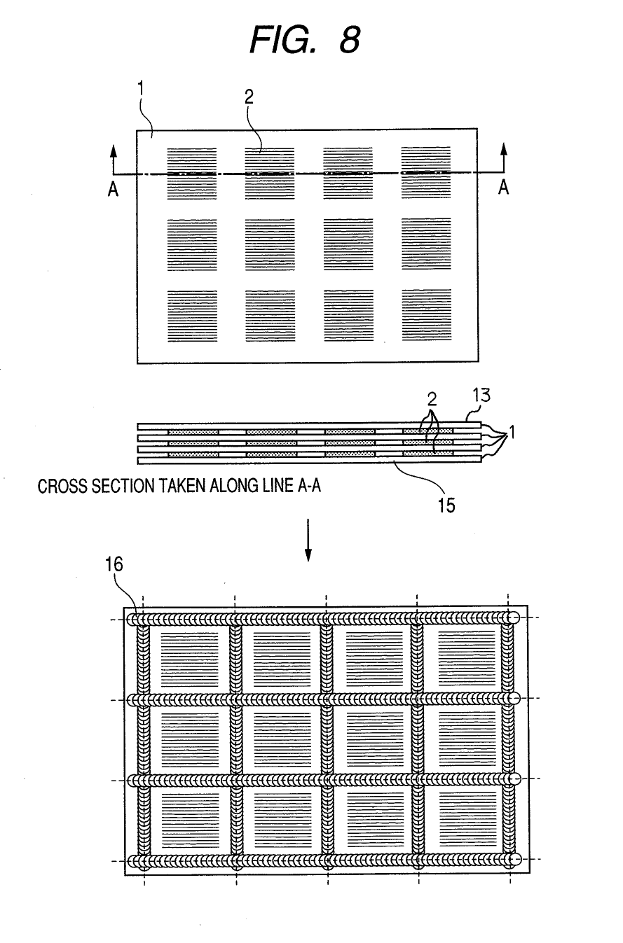

FIG. 8 illustrates a fourth embodiment in which sheets are laminated and joined together using the friction stir joining of the invention. Pd sheets 2 smaller than an Al sheet 1 are arranged at equal intervals in a matrix pattern over the Al sheet 1, and another Al sheet 1 is laminated over them. The Pd sheets 2 and the Al sheet s1 are alternately laminated in sandwich structure in a sandwich structure. First, a welding tool 8presses against an outer surface 13 of an uppermost (top)-layer Al sheet 1 or a lowermost (bottom 15)-layer Al sheet 1. A position to be pressed on the outer surface 13 of the Al sheet 1 with the welding tool 8 is a lattice-like area where the Pb sheets 2 don't exist just under the Al sheet 1. When the probe 9 rotates while pressing against the surface of the Al sheet 1, only approximately pressed portion of laminated Al sheets 1 soften and plastically flow in turn from an upper side to a lower side (or a lower side to a upper side) by intrusion of the probe 9 to the laminated Al sheets 1. Finally, the welding tool 8 reaches up to the lowermost Al sheet 1 (or uppermost Al sheet 1). Then the welding tool is moved in the direction (a direction along lattice-like line) to be welded, and the friction stir welding is continued. After all the joining areas are subjected to friction stir welding, the laminated member is cut along the join (welded) lines 16. According to this embodiment, it is possible to fabricate multiple parts of laminated structure at a time, and to simplify the process of manufacturing.

What is claimed is:

1. A friction stir welding method of alternately laminating each first metal sheet and each second metal sheet in three or more layers, wherein a melting point of said second metal sheet is higher than that of said first metal sheet, and welding them together by friction stir welding,
wherein, under a state where those three or more metal sheets are so laminated that an edge of said first metal sheet protrudes outward of an edge of said second metal sheet, said friction stir welding is executed by pressing a welding tool against only the edge of said first metal sheet.

2. The friction stir welding method according to claim 1,
an protruding section of said first metal sheet softens and plastically flows around a recessed edge of said second metal sheet by said friction stir welding and a resulting plastic flow section of said first metal sheet covers the edge of said second metal sheet.

3. The friction stir welding method according to claim 2,
wherein a reaction layer between both said first metal sheet and said second metal sheet is formed at an interface between the edge of said second metal sheet and said plastic flow section of said first metal sheet.

4. The friction stir welding method according to claim 2,
wherein upper and lower faces and the edge of said second metal sheet are covered with said first metal sheet.

5. A laminate formed by alternately laminating each first metal sheet and each second metal sheet in three or more layers, wherein a melting point of said second metal sheet is higher than that of said first metal sheet, and joining them together,
wherein upper and lower faces and edges of said second metal sheet are covered with said first metal sheet.

6. The laminate according to claim 5,
wherein the edge of said second metal sheet and said first metal sheet are joined to each other via a reaction layer formed between them.

7. A hydrogen reactor comprising a catalyst sheet for causing dehydrogenation reaction in an organic compound that repeatedly chemically stores and discharges hydrogen, a hydrogen separation membrane for separating hydrogen generated by dehydrogenation reaction, and a hydrogen channel sheet with a channel for hydrogen that permeated said hydrogen separation membrane, wherein those sheets are laminated in a sandwich structure,
wherein two members among said catalyst sheet, hydrogen separation membrane, and hydrogen channel sheet have a melting point lower than the other member among them, and
join sections of said catalyst sheet, hydrogen separation membrane, and hydrogen channel sheet are joined to each other by a plastic flow of only said lower melting point-two members of them, wherein said plastic flow is caused by friction stir welding.

8. The hydrogen reactor according to claim 7,
said join sections are positioned inside through holes formed in a lamination plane of said three members.

9. The hydrogen reactor according to claim 7,
wherein said hydrogen separation membrane is formed of a metal based on Pd, Nb, Zr, V, or Ta or an alloy thereof, and said catalyst sheet and hydrogen channel sheet are a metal based on Cu, Ni, Al, Si, Ti, or the like or an alloy thereof.

10. The hydrogen reactor according to claim 9,
wherein said catalyst sheet and hydrogen channel sheet are formed of a same kind of material.
